(19) United States
(12) Patent Application Publication
(10) Pub. No.: US 2017/0171535 A1
(43) Pub. Date: Jun. 15, 2017

(54) THREE-DIMENSIONAL DISPLAY APPARATUS AND METHOD FOR CONTROLLING THE SAME

(71) Applicant: Hyundai Motor Company, Seoul (KR)

(72) Inventors: Ju Hyuk Kim, Seongnam (KR); Yu Kyoung Sung, Incheon (KR); Ju Hyun Kim, Seoul (KR)

(21) Appl. No.: 15/206,882

(22) Filed: Jul. 11, 2016

(30) Foreign Application Priority Data
Dec. 9, 2015 (KR) 10-2015-0175261

(51) Int. Cl. H04N 13/04; B60R 1/00; B60K 35/00

(52) U.S. Cl. CPC H04N 13/0484; H04N 13/0409; H04N 13/0472; H04N 13/0497; B60K 35/00; B60R 1/00; B60K 2350/1072; B60K 2350/2017; B60K 2350/30; B60K 2350/352; B60K 2350/901; B60K 2350/96

(57) ABSTRACT

A 3D display apparatus includes: a display including a display panel displaying information and a barrier panel overlapped with a front surface of the display panel; a camera configured to obtain an image of a user; a graphic processor configured to control a barrier of the barrier panel; and a controller configured to recognize a sight line of the user or a face of the user using the image of the user obtained by the camera, to set a fixed focus of the camera in the sight line or the face of the user recognized by the camera, to determine whether an error occurs in the recognition of the sight line or the face of the user by the camera after the fixed focus is set, and to control the graphic processor based on whether the error occurs so as to control the barrier in the recognition of the sight line or the face of the user.

### CROSS-REFERENCE TO RELATED APPLICATION

This application claims the benefit of and priority to Korean Patent Application No. 10-2015-0175261, filed on Dec. 9, 2015 in the Korean Intellectual Property Office, the disclosure of which is incorporated herein in its entirety by reference.

### TECHNICAL FIELD

The present disclosure relates generally to a three-dimensional (3D) display apparatus and, more particularly, to a 3D display apparatus in which alignment of a barrier of a 3D panel is controlled depending on an error form in the case in which a driver's sight line or face recognition error occurs in the 3D display apparatus, and a method for controlling the same.

### BACKGROUND

Recently, autostereoscopic three-dimensional (3D) techniques which can be utilized for viewing a stereoscopic image without wearing 3D glasses have been developed. A typical example of an autostereoscopic 3D display scheme is a parallax barrier scheme. The parallax barrier scheme involves disposing a barrier in which numerous holes are drilled in front of a screen. The holes formed in the barrier are disposed so that pixels behind the holes are alternately viewed, such that different images arrive at both eyes of the viewer, respectively, without wearing glasses, thereby making it possible to experience a 3D effect.

Additionally, a stereoscopic cluster implementing the autostereoscopic 3D technology has been applied in a vehicle. However, the stereoscopic cluster has a narrow viewing angle, such that even though a user's (e.g., driver's) sight line slightly moves, the user's sight line is out of the viewing angle. In order to solve this viewing angle problem of the stereoscopic cluster in conventional implementations, a driver's sight line or face can be recognized using a camera, movement of the driver's sight line or face can be tracked so as to be focused on the corresponding driver's sight line or face, and a barrier of a 3D panel can be controlled depending on the tracked movement of the driver's sight line or face. Here, the barrier of the 3D panel is aligned with respect to one driver.

However, in the conventional implementations described above, if a plurality of sight lines or faces are positioned in a photographing region (recognition region) of the camera, or the driver turns his/her head left or right causing face recognition to fail, the barrier of the 3D panel is not normally controlled and crosstalk is generated.

### SUMMARY

The present disclosure has been made to solve the above-mentioned problems occurring in the related art, while advantages achieved by the prior art are maintained intact.

An aspect of the present disclosure provides a three-dimensional (3D) display apparatus in which a barrier of a 3D panel is controlled depending on an error form in the case in which an error occurs when recognizing a driver's sight line or face in the 3D display apparatus, and a method for controlling the same.

According to embodiments of the present disclosure, a 3D display apparatus includes: a display including a display panel displaying information and a barrier panel overlapped with a front surface of the display panel; a camera configured to obtain an image of a user; a graphic processor configured to control a barrier of the barrier panel; and a controller configured to recognize a sight line of the user or a face of the user using the image of the user obtained by the camera, to set a fixed focus of the camera in the sight line or the face of the user recognized by the camera, to determine whether an error occurs in the recognition of the sight line or the face of the user by the camera after the fixed focus is set, and to control the graphic processor based on whether the error occurs so as to control the barrier in the recognition of the sight line or the face of the user.

The controller may be further configured to set the focus on the sight line or the face of the user recognized by the camera and to fix the corresponding focus when the set focus is maintained for a predetermined time or more.

The controller may be further configured to control the barrier based on movement of the sight line or the face of the user corresponding to the fixed focus when one or more other sight lines or faces of other users are recognized, such that the error occurs in the recognition of the sight line or the face of the user.

The controller may be further configured to set the focus on the sight line or the face of the user recognized just before the recognition fails to the fixed focus when the one or more other sight lines or faces of other users are not recognized.

The controller may be further configured to control the barrier based on the set focus.

The controller may be further configured to control the barrier based on movement of the recognized sight line or face of the user when the sight line or the face of the user is normally recognized.

Furthermore, according to embodiments of the present disclosure, a method for controlling a 3D display apparatus includes: recognizing a sight line of a user or a face of a user through a camera when a vehicle is started; setting a fixed focus of the camera in the sight line or the face of the user recognized by the camera; determining whether an error occurs in the recognition of the sight line or the face of the user by the camera after the fixed focus is set; and controlling a barrier based on whether the error occurs in the recognition of the sight line or the face of the user. The barrier is a component of a barrier panel which overlaps with a front surface of a display panel which displays information.

The method may further include: setting the focus on the recognized sight line or face of the user; and fixing the set focus when the set focus is maintained for a predetermined time or more.

The determining of whether the error occurs may include:

determining whether one or more other sight lines or faces of other users are recognized when the error occurs in the recognition of the sight line or the face of the user; and controlling the barrier based on movement of the sight line or the face of the user corresponding to the fixed focus when the one or more other sight lines or faces of other users are recognized.

The determining of whether the error occurs may further include: setting the focus on the sight line or the face of the user recognized just before the recognition fails to the fixed focus when the one or more other user's sight lines or faces are not recognized; and controlling the barrier based on the fixed focus.

The method may further include: tracking movement of the recognized sight line or face of the user; and controlling the barrier based on a result of the tracking when the error does not occur in the recognition of the sight line or the face of the user.

Furthermore, according to embodiments of the present disclosure, a non-transitory computer readable medium contains program instructions for controlling a 3D display apparatus that: recognize a sight line of a user or a face of a user through a camera when a vehicle is started; set a fixed focus of the camera in the sight line or the face of the user recognized by the camera; determine whether an error occurs in the recognition of the sight line or the face of the user by the camera after the fixed focus is set; and control a barrier based on whether the error occurs in the recognition of the sight line or the face of the user. The barrier is a component of a barrier panel which overlaps with a front surface of a display panel which displays information.

### BRIEF DESCRIPTION OF THE DRAWINGS

The above and other objects, features and advantages of the present disclosure will be more apparent from the following detailed description taken in conjunction with the accompanying drawings.

FIG. 1 is a block diagram illustrating a three-dimensional (3D) display apparatus according to embodiments of the present disclosure.

FIG. 2 is a view for describing a control of a barrier panel according to embodiments of the present disclosure.

FIG. 3 is a flow chart illustrating a method for controlling a 3D display apparatus according to embodiments of the present disclosure.

FIG. 4A is an illustrated view illustrating a control of a barrier in the case in which two or more slight lines or faces are recognized in a recognition region of a camera according to the present disclosure.

FIG. 4B is an illustrated view illustrating a control of a barrier in the case in which recognition of a user's slight line or face that is out of a recognition region of a camera fails according to the present disclosure.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, 25 all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Furthermore, the controller of the present disclosure may be embodied as non-transitory computer readable media containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

Hereinafter, embodiments of the present disclosure will be described in detail with reference to the accompanying drawings.

Referring now to the disclosed embodiments, the present disclosure relates to a three-dimensional (3D) display apparatus capable of displaying a two-dimensional (2D) image and/or a 3D image. The 3D display apparatus, which is an autostereoscopic 3D display apparatus using a 3D panel, may be any one of display means such as a stereoscopic cluster, an AVN (Audio-Video-Navigation), a rear monitor, and the like.

In the present disclosure, the case in which the 3D display apparatus is implemented by a cluster of a vehicle will be described by way of example, without limitation thereto, in order to assist in the understand of explanation.

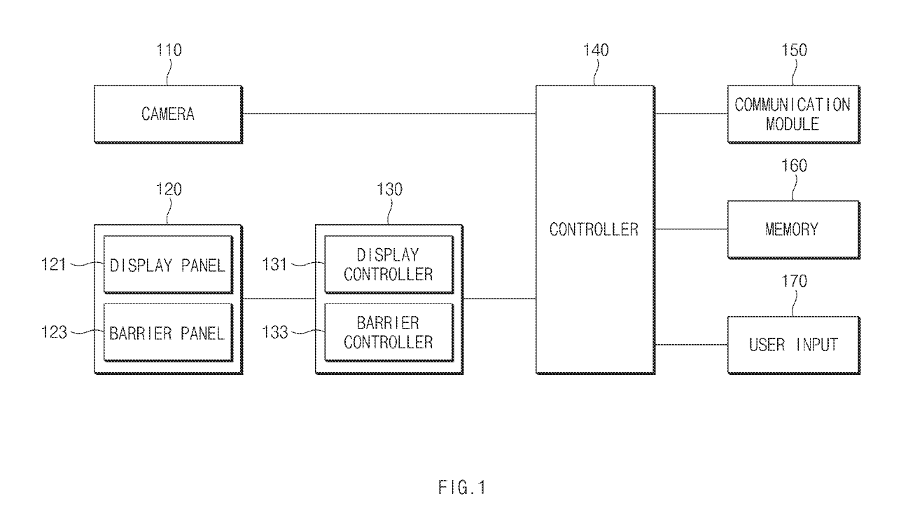

FIG. 1 is a block diagram illustrating a 3D display apparatus according to embodiments of the present disclosure.

As illustrated in FIG. 1, the 3D display apparatus is configured to include a camera 110, a display 120, a graphic processor 130, a controller 140, a communication module 150, a memory 160, and a user input 170.

The camera 110 is installed to be directed to a user (e.g., driver, passenger, or the like) in a vehicle and obtains an image of the user. The image obtained through the camera 110 is used to recognize a user's sight line or face.

The camera 110 may be implemented by any one of image sensors such as a charge coupled device (CCD) image sensor, a complementary metal oxide semi-conductor (CMOS) image sensor, a charge priming device (CPD) image sensor, a charge injection device (CID) image sensor, and the like.

The display 120 displays a 2D image and/or a 3D image. The display 120 includes a display panel 121 and a barrier panel 123.

The display panel 121 may be divided into two or more display regions in which different kinds of information are displayed. For example, in the case in which an entire display region of the display panel 121 is divided into three display regions, a tacho gauge (i.e., an engine tachometer) is displayed in a first display region, a speed gauge is displayed in a second display region, and a fuel gauge and a coolant temperature are displayed in a third display region.

The display panel 121 displays a 3D image or a 2D image in each display region. Here, the 3D image includes a left-eye image and a right-eye image. That is, the display panel 121 alternately disposes and displays the left-eye image and the right-eye image. For example, the display panel 121 displays the left-eye image in odd numbered (1, 3, 5, pixels, and displays the right-eye image in even numbered (2, 4, 6, pixels. The display panel 121 is implemented by any one of a liquid crystal display (LCD), a thin film transistor-liquid crystal display (TFT-LCD), an organic light-emitting diode (OLED), and the like.

The barrier panel 123 is disposed to overlap with a front surface of the display panel 121, and is configured of a plurality of barrier pixels. For example, in the case in which a resolution of the display panel 121 is 1920×720, the number of barrier pixels is 960 corresponding to a half of 1920, which is a horizontal resolution of the display panel 121.

The graphic processor 130 converts a digital signal into an image signal, transmits the converted image signal to the display 120, and controls the barrier panel 123 to output the 2D image and/or the 3D image. The graphic processor 130 includes a display controller 131 and a barrier controller 133.

The display controller 131 converts digital image data input from the controller 140 into an analog image signal, and outputs the analog image signal to the display panel 121.

The barrier controller 133 controls the turn-on or turn-off of the barrier pixels configuring the barrier panel 123. In this regard, the barrier controller 133 turns on all the barrier pixels to form a barrier, and turns off all the barrier pixels to release the barrier. Here, the barrier serves to block one-sided information so that different images may be viewed in both eyes.

Although the case in which all the barrier pixels configuring the barrier panel 123 are simultaneously turned on or turned off has been described in the present embodiments, the respective barrier pixels may also be implemented to be independently controlled.

The controller 140 outputs various kinds of information such as vehicle information, driving information, road guidance information, and the like, to the display controller 131. When a display mode is set, the controller 140 transmits corresponding set information to the graphic processor 130. The display controller 131 of the graphic processor 130 generates an input image as the 3D image or generates the input image as the 2D image on the basis of the set information output from the controller 140. In addition, the barrier controller 133 controls the turn-on or the turn-off of the barrier pixels on the basis of the set information.

The controller 140 recognizes a user's sight line or face through the camera 110 when the vehicle is started up. The controller 140 sets a focus in the recognized sight line or face. For example, the controller 140 sets the focus in the center of a left eye and a right eye of the recognized face.

The controller fixes the focus set in the recognized sight line or face when the set focus is maintained for a predetermined time or more. In other words, the controller 140 sets the set focus to a fixed focus when the set focus is maintained for a reference time or more. Then, the controller 140 continuously recognizes the user's sight line or face through the camera 110 on the basis of the fixed focus.

The controller 140 tracks movement of the recognized user's sight line or face in the case in which the user's sight line or face is normally recognized. In addition, the controller 140 controls the barrier panel 123 based on the movement of the tracked user's sight line or face, thereby aligning the barrier. The controller 140 also determines an error form (i.e., whether an error occurs) in the case in which the user's sight line or face is not normally recognized. Specifically, the error form can be a case in which the user's sight line or face is out of a recognition region of the camera 110, such that recognition of the user's sight line or face fails, or a case in which one or more other user's sight lines or faces are additionally recognized in the recognition region of the camera 110.

The controller 140 further tracks movement of the user's sight line or face corresponding to the fixed focus and controls alignment of the barrier depending on the tracked movement of the user's sight line or face, in the case in which one or more other user's sight lines or faces are recognized. The controller 140 also sets a focus set in a user's sight line or face recognized just before the recognition of the user's sight line or face fails to the fixed focus, in the case in which the user's sight line or face is out of the recognition region of the camera 110 due to an action of the user, for example, a turn of a head, movement of the head, or the like, such that the recognition of the user's sight line or face fails. The controller 140 controls the barrier panel 123 depending on the set fixed focus to align the barrier.

In addition, the controller 140 determines whether the user's sight line or face is normally or abnormally out of the recognition region of the camera 110 in the case in which the user's sight line or face is out of the recognition region of the camera 110. The controller 140 determines whether or not the user's sight line or face is normally out of the recognition region of the camera 110 on the basis of vehicle information obtained through the communication module 150. For example, the controller 140 can determine that the user's sight line or face is normally out of the recognition region of the camera 110 when a turn signal lamp is turned on or a warning system such as a blind spot detection (BSD) system, a lane keeping assist system (LKAS), a lane departure warning system (LDWS), or the like, is operated. In this case, the controller 140 maintains alignment of the barrier just before the recognition of the user's sight line or face.

Meanwhile, the controller 140 sets a barrier central value to which the focus may be most rapidly moved in consideration of all the various cases for the movement of the user's sight line or face when the user's sight line or face is abnormally out of the recognition region of the camera 110. Although the case in which the focus set in the user's sight line or face recognized just before the recognition of the user's sight line or face fails is set to the fixed focus has been described by way of example in the present embodiments, the present disclosure is not limited thereto, but may also be implemented so that a focus set in a user's sight line or face first recognized after the vehicle is started up is set to the fixed focus.

The communication module 150 performs data communication with an electronic control unit (ECU) and various sensors mounted in the vehicle through a vehicle network. The controller 140 collects vehicle information (e.g., a vehicle speed, an amount of remaining fuel, an engine speed, turn on/off of a turn signal lamp, and the like) through the communication module 150. As the vehicle network, any one of a controller area network (CAN), a media oriented systems transport (MOST) network, a local interconnect network (LIN), and a Flexray may be used, by way of example.

The memory 160 may store a program for an operation of the controller 140 therein, and temporarily store input/out data therein.

The memory 160 may include at least one of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk, by way of example.

The user input 170 generates data depending on a manipulation of the user. The user input 170 may be implemented by a button, a key, a keypad, a touch pad, a touch screen, or the like.

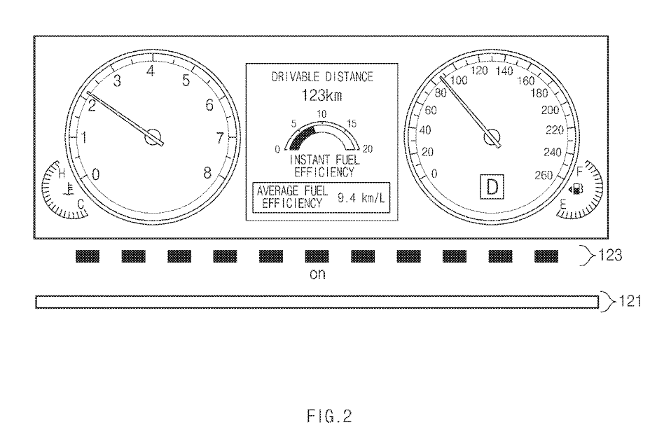

FIG. 2 is a view for describing a control of a barrier panel according to embodiments of the present disclosure.

As illustrated in FIG. 2, the display panel 121 and the barrier panel 123 are disposed to be overlaid with each other. All the barrier pixels configuring the barrier panel 123 are turned on or turned off at a time.

The barrier controller 133 turns on barrier pixels corresponding to all the display regions of the display panel 121 to form the barrier, in the case in which the display 120 is operated in a 3D display mode. In addition, the barrier controller 133 turns off barrier pixels in a region corresponding to all the display regions of the display panel 121 to release the barrier, in the case in which the display 120 is operated in a 2D display mode.

In addition, the barrier controller 133 controls the turn-on or the turn-off of the barrier pixels depending on the focus set depending on the recognition of the user's sight line or face to align the barrier.

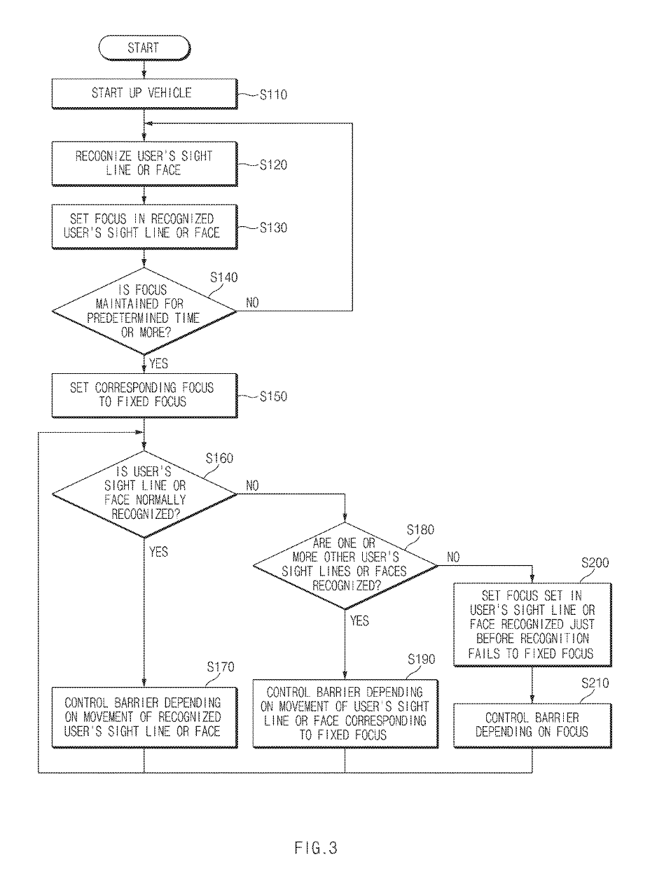

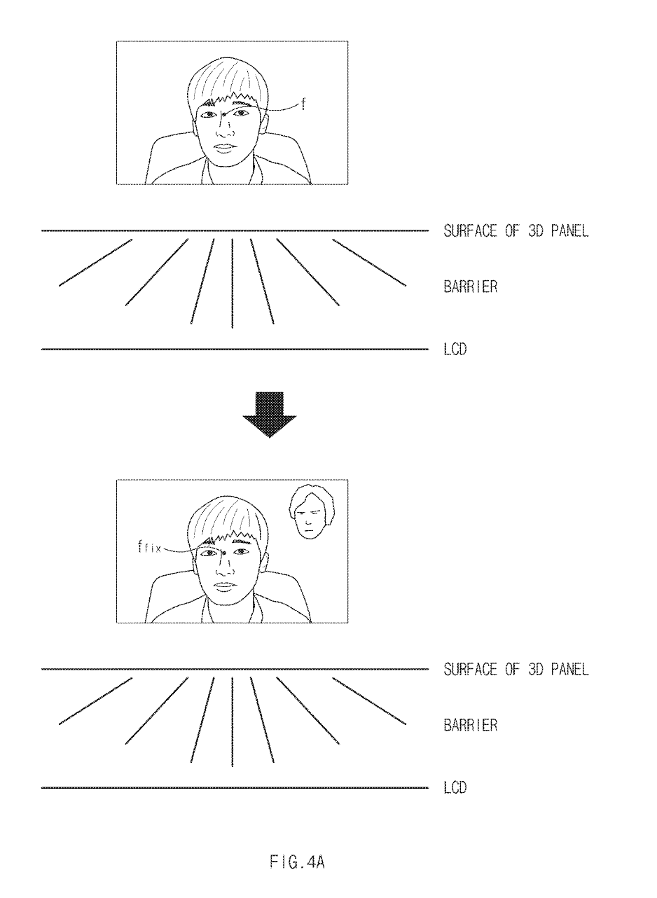

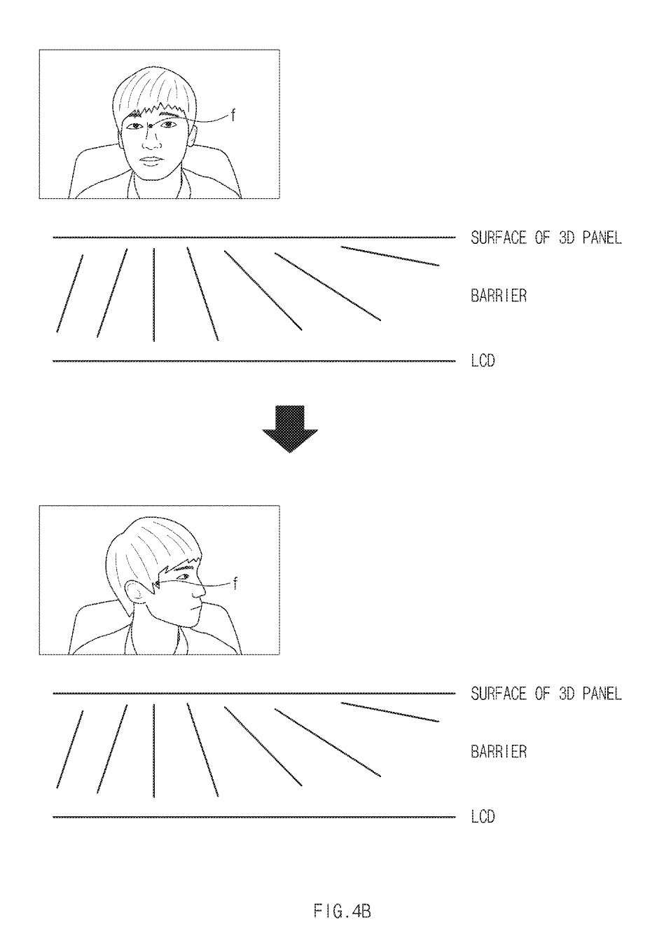

FIG. 3 is a flow chart illustrating a method for controlling a 3D display apparatus according to embodiments of the present disclosure, FIG. 4A is an illustrated view illustrating a control of a barrier in the case in which two or more slight lines or faces are recognized in a recognition region of a camera according to the present disclosure, and FIG. 4B is an illustrated view illustrating a control of a barrier in the case in which recognition of a user's slight line or face that is out of a recognition region of a camera fails according to the present disclosure.

The controller 140 recognizes the user's sight line (i.e., sight line vector) or face through the camera 110 when the vehicle is started up (S110 and S120).

The controller 140 sets the focus in the recognized user's sight line or face (S130). For example, the controller 140 sets the focus in the center of the left eye and the right eye of the user.

The controller 140 sets the corresponding focus to the fixed focus when the set focus is maintained for a predetermined time or more (S140 and S150). The controller 140 fixes the focus set in the recognized user's sight line or face.

The controller 140 determines whether or not the user's sight line or face is normally recognized through the camera 110 (S160) after the fixed focus is set. The controller 140 performs the recognition of the user's sight line or face through the camera 110 and confirms whether or not an error (i.e., a fail condition) occurs in the recognition.

The controller 140 controls the alignment of the barrier depending on the movement of the recognized user's sight line or face (S170) when the user's sight line or face is normally recognized. The controller 140 tracks the movement of the recognized user's sight line or face and controls the barrier panel 123 based on the tracked movement of the user's sight line or face to align the barrier.

Meanwhile, when the user's sight line or face is not normally recognized in S160, the controller 140 determines whether or not one or more other user's sight lines or faces are additionally recognized (S180).

The controller 140 controls the barrier based on movement of a user's sight line or face corresponding to the fixed focus (S190) when one or more other user's sight lines or faces are recognized. The controller 140 ignores recognition of another user's sight line or face and tracks only movement of the user's sight line or face corresponding to the fixed focus, when another user's sight line or face other than the user's sight line or face corresponding to the fixed focus is recognized. For example, as illustrated in FIG. 4A, when a user other than the user is positioned in the recognition region of the camera 110, the controller 140 tracks only the movement of the user's sight line or face corresponding to the fixed focus f_{fix} and controls the alignment of the barrier depending on the tracked movement.

In the case in which one or more other user's sight lines or faces are not recognized and the recognition of the user's sight line or face fails, the controller 140 sets the focus set in the user's sight line or face recognized just before the recognition of the user's sight line or face fails to the fixed focus (S200). For example, as illustrated in FIG. 4B, in the case in which the user turns his/her head, such that the recognition of the user's sight line or face fails, a focus f set in a user's sight line or face that has been normally recognized recently is set to the fixed focus f_{fix}.

Although the case in which the focus set in the user's sight line or face recognized just before the recognition of the user's sight line or face fails is set to the fixed focus has been described by way of example in the present embodiments, the present disclosure is not limited thereto, but may also be implemented so that a focus set in a user's sight line or face first recognized after the vehicle is started up is set to the fixed focus.

The controller 140 controls the barrier panel 123 depending on the set fixed focus to control the alignment of the barrier (S210).

As described above, according to the embodiments of the present disclosure, in the case in which the error occurs in the recognition of the user's sight line or face in the 3D display apparatus, the barrier of the 3D panel is controlled depending on the error form, thereby making it possible to implement a 3D display. In addition, according to the embodiments of the present disclosure, occurrence of a phenomenon such as a crosstalk due to failure of the recognition of the user's sight line or face is prevented, thereby making it possible to enable a natural 3D display.

Hereinabove, although the present disclosure has been described with reference to embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A three-dimensional (3D) display apparatus comprising:
a display including a display panel displaying information and a barrier panel overlapped with a front surface of the display panel;
a camera configured to obtain an image of a user;
a graphic processor configured to control a barrier of the barrier panel; and
a controller configured to recognize a sight line of the user or a face of the user using the image of the user obtained by the camera, to set a fixed focus of the camera in the sight line or the face of the user recognized by the camera, to determine whether an error occurs in the recognition of the sight line or the face of the user by the camera after the fixed focus is set, and to control the graphic processor based on whether the error occurs so as to control the barrier in the recognition of the sight line or the face of the user.

2. The 3D display apparatus according to claim 1, wherein the controller is further configured to set the focus on the sight line or the face of the user recognized by the camera and to fix the corresponding focus when the set focus is maintained for a predetermined time or more.

3. The 3D display apparatus according to claim 1, wherein the controller is further configured to control the barrier based on movement of the sight line or the face of the user corresponding to the fixed focus when one or more other sight lines or faces of other users are recognized, such that the error occurs in the recognition of the sight line or the face of the user.

4. The 3D display apparatus according to claim 1, wherein the controller is further configured to set the focus on the sight line or the face of the user recognized just before the recognition fails to the fixed focus when the one or more other sight lines or faces of other users are not recognized.

5. The 3D display apparatus according to claim 4, wherein the controller is further configured to control the barrier based on the set focus.

6. The 3D display apparatus according to claim 1, wherein the controller is further configured to control the barrier based on movement of the recognized sight line or face of the user when the sight line or the face of the user is normally recognized.

7. A method for controlling a 3D display apparatus, comprising:
recognizing a sight line of a user or a face of a user through a camera when a vehicle is started;
setting a fixed focus of the camera in the sight line or the face of the user recognized by the camera;
determining whether an error occurs in the recognition of the sight line or the face of the user by the camera after the fixed focus is set; and
controlling a barrier based on whether the error occurs in the recognition of the sight line or the face of the user,
wherein the barrier is a component of a barrier panel which overlaps with a front surface of a display panel which displays information.

8. The method for controlling a 3D display apparatus according to claim 7, further comprising:
setting the focus on the recognized sight line or face of the user; and
fixing the set focus when the set focus is maintained for a predetermined time or more.

9. The method for controlling a 3D display apparatus according to claim 7, wherein the determining of whether the error occurs comprises:
determining whether one or more other sight lines or faces of other users are recognized when the error occurs in the recognition of the sight line or the face of the user; and
controlling the barrier based on movement of the sight line or the face of the user corresponding to the fixed focus when the one or more other sight lines or faces of other users are recognized.

10. The method for controlling a 3D display apparatus according to claim 9, wherein the determining of whether the error occurs further comprises:
setting the focus on the sight line or the face of the user recognized just before the recognition fails to the fixed focus when the one or more other user's sight lines or faces are not recognized; and
controlling the barrier based on the fixed focus.

11. The method for controlling a 3D display apparatus according to claim 7, further comprising:
tracking movement of the recognized sight line or face of the user; and
controlling the barrier based on a result of the tracking when the error does not occur in the recognition of the sight line or the face of the user.

12. A non-transitory computer readable medium containing program instructions for controlling a 3D display apparatus, the computer readable medium comprising program instructions that:
recognize a sight line of a user or a face of a user through a camera when a vehicle is started;
set a fixed focus of the camera in the sight line or the face of the user recognized by the camera;
determine whether an error occurs in the recognition of the sight line or the face of the user by the camera after the fixed focus is set; and
control a barrier based on whether the error occurs in the recognition of the sight line or the face of the user,
wherein the barrier is a component of a barrier panel which overlaps with a front surface of a display panel which displays information.
